(19) United States
(12) Patent Application Publication
(10) Pub. No.: US 2010/0166060 A1
(43) Pub. Date: Jul. 1, 2010

(54) VIDEO TRANSCODER RATE CONTROL

(75) Inventors: Tomohiro EZURE, Tsukuba (JP); Akira OSAMOTO, Inashiki (JP)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/347,702

(22) Filed: Dec. 31, 2008

(51) Int. Cl. H04N 7/26

(52) U.S. Cl. 375/240.03; 375/E07.139; 375/E07.198

(57) ABSTRACT

A system and method for transcoding a video bitstream is disclosed herein. A video transcoder in accordance with the present disclosure includes a video decoder, a video encoder, and a rate controller. The video decoder decodes an encoded source video bitstream to produce an image. The video encoder encodes the image to produce a transcoded video bitstream. The rate controller controls the bitrate of the transcoded video bitstream. The rate controller includes a macroblock level controller that provides a transcoder quantization parameter to the encoder. The macroblock level controller derives the transcoder quantization parameter applied to a transcoder macroblock by the encoder, at least in part, from a source quantization parameter of a corresponding macroblock in the source video bitstream.

### BACKGROUND

Numerous video coding standards are available to facilitate digital video compression. Examples of available video coding standards include MPEG-1, MPEG-2, and MPEG-4 part 2 standardized by the International Organization for Standardization (“ISO”), H.261 and H.263 standardized by the International Telecommunications Union (“ITU”), and H.264, also known as Advanced Video Coding (“AVC”) or MPEG-4 part 10 standardized jointly by both ISO and ITU. The video compression standards define decoding techniques and at least a portion of the corresponding encoding techniques used to compress and decompress video. Video compression techniques include variable length coding, motion compensation, quantization, and frequency domain transformation.

Some video coding standards arrange images and sub-images in a hierarchical fashion. A group of pictures (“GOP”) constitutes a set of consecutive pictures. Decoding may begin at the start of any GOP. A GOP can include any number of pictures, and GOPs need not include the same number of pictures.

Each picture encoded can be subdivided into macroblocks representing the color and luminance characteristics of a specified number of pixels. In MPEG coding for example, a macroblock includes information related to a 16×16 block of pixels.

A picture can be either field-structured or frame structured. A frame-structured picture contains information to reconstruct an entire frame, i.e., two fields, of data. A field-structured picture contains information to reconstruct one field. If the width of each luminance frame (in picture elements or pixels) is denoted as C and the height as R (C is for columns, R is for rows), a frame-structured picture contains information for C×R pixels and a field-structured picture contains information for C×R/2 pixels.

A GOP can contain three types of pictures, intra coded pictures (“I-pictures”), predictively coded pictures (“P-pictures”), and bi-predictively coded pictures (“B-pictures”). The distinguishing feature among these picture types is the compression method that is used. The first type, I-pictures, are compressed independently of any other picture. Although there are no fixed upper bound on the distance between I pictures, it is expected that they will be interspersed frequently throughout a sequence to facilitate random access and other special modes of operation. P-pictures are reconstructed from the compressed data in that picture and recently reconstructed fields from previously displayed I- or P-pictures. B-pictures are reconstructed from the compressed data in that picture plus reconstructed fields from previously displayed I- or P-pictures and reconstructed fields from I- or P-pictures that will be displayed in the future. Because reconstructed I- or P-pictures can be used to reconstruct other pictures, they are sometimes called reference pictures.

To reduce spatial redundancy video data is transformed (e.g., by application of a discrete cosine transform (“DCT”)), the DCT coefficients are quantized, and the quantized coefficients are entropy coded (e.g., Huffman coded). The transform is lossless, but quantization is lossy. In MPEG coding quantization consists of dividing each coefficient by w×QP where w is a weighting factor and Qp is a macroblock quantizer. The weighting factor and the macroblock quantizer can vary, and are transmitted as part of the video bitstream.

Coding standards support both constant bit rate (“CBR”) and variable bit rate (“VBR”) video bitstreams. A CBR bitstream fills a decoder buffer with compressed data at a constant rate. A VBR bitstream fills the buffer at a maximum rate. In order to avoid overflow or underflow of decoder buffers, a video encoder can constrain the bit rate of the output video stream by considering the reception of the bitstream by an idealized decoder, for example, a hypothetical reference decoder in H.264 or a virtual buffer verifier in MPEG.

An abundance of modern video devices provide playback of video encoded in one or another of the available video coding formats. These devices vary widely in display resolution, acceptable code formats, and other parameters. Unfortunately, video content is generally provided in forms that are incompatible with at least some display devices.

Transcoding is applied to transform video data from a format not useable by a device to a useable format. Transcoding is the ability to take existing video content and change the format, bit rate, or resolution in order to play the video on a video playback device. Transcoding recodes digital content from one compressed format to another to enable transmission over different media and/or playback using various video devices. The wide variety of available video devices and their varied capabilities make transcoding an important technology for delivering digital video content. For example, to move video content (e.g., high definition video) from a set-top box to a portable media player or cellular telephone, transcoding changes the resolution of the content in accordance with the lower resolution screens, and a lowers the bit rate of the video stream in accordance with the portable device's processing capabilities and power constraints.

A transcoder, like other video encoders, should provide a video stream at a bit-rate that allows the display device to access each picture in the video stream when needed without overflowing or underflowing any video data buffers associated with the device's decoder. Control of the video stream's bit rate is termed “rate control.” Existing rate control methods can require excessive computational resources. Efficient transcoder rate control methods are desirable.

### SUMMARY

Accordingly, various techniques are herein disclosed for improving transcoder rate control. In accordance with at least some embodiments, a video transcoder includes a video decoder, a video encoder, and a rate controller. The video decoder decodes an encoded source video bitstream to produce an image. The video encoder encodes the image to produce a transcoded video bitstream. The rate controller controls the bitrate of the transcoded video bitstream. The rate controller includes a macroblock level controller that provides a transcoder quantization parameter to the encoder. The macroblock level controller derives the transcoder quantization parameter applied to a transcoder macroblock by the encoder, at least in part, from a source quantization parameter of a corresponding macroblock in the source video bitstream..

In other embodiments, a transcoding method includes decoding a source video bitstream. A transcoder quantization parameter applied to a transcoded macroblock, is derived, at least in part, from a source quantization parameter of a macroblock in the source video bitstream. A macroblock is encoded using the transcoder quantization parameter.

In yet other embodiments, a video bitrate controller includes a picture controller and a macroblock controller. The picture controller computes, for each picture, a single quantizer scaling value applicable to all macroblocks of the picture. The macroblock controller computes an encode quantization parameter used to encode a macroblock of the picture. The macroblock controller computes the encode quantization parameter as a product of the quantizer scaling value and a source quantization parameter extracted from a video bitstream.

### BRIEF DESCRIPTION OF THE DRAWINGS

In the following detailed description, reference will be made to the accompanying drawings, in which:

FIG. 1 shows an exemplary block diagram of an transcoder in accordance with various embodiments;

FIG. 2 shows an exemplary group of pictures (“GOP”) estimation in accordance with various embodiments;

FIG. 3 shows an exemplary set of source macroblocks contributing to a transcoded macroblock in accordance with various embodiments;

FIG. 4 shows exemplary source frame and field macroblocks contributing to transcoded frame and field macroblocks in accordance with various embodiments;

FIG. 5 shows exemplary source frame and field macroblocks contributing to transcoded frame and field macroblocks of a horizontally halved image in accordance with various embodiments;

FIG. 6 shows a flow diagram for transcoder constant bit rate (“CBR”) rate control in accordance with various embodiments; and

FIG. 7 shows a flow diagram for transcoder variable bit rate (“VBR”) rate control in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” and “e.g.” are used in an open-ended fashion, and thus should be interpreted to mean “including, but not limited to . . . ”. The term “couple” or “couples” is intended to mean either an indirect or direct wired or wireless connection. Thus, if a first component couples to a second component, that connection may be through a direct connection, or through an indirect connection via other components and connections. The term “system” refers to a collection of two or more hardware and/or software components, and may be used to refer to an electronic device or devices, or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein are various systems and methods for improving transcoder rate control in both constant and variable bit rate video streams. Transcoder rate control algorithms, unlike stand-alone encoder rate control systems, can benefit from use of information contained in a source bitstream. When the source bitstream is generated with good rate control, the bitstream's quantization parameters can be applied to enable generation of a high-quality transcoded video stream. For example, while some rate control schemes (e.g., MPEG-2 TM5) fail to adequately provide for abrupt scene changes, encoders used to generate broadcast bitstreams employ sophisticated rate control algorithms that adapt gracefully to scene changes. Broadcast encoders also implement macroblock level adaptive quantization algorithms. The transcoders described herein, take advantage of the sophisticated rate control and macroblock level adaptive quantization algorithms applied by broadcast encoders to improve transcoded picture quality.

Embodiments of the present disclosure use the quantization parameters of a source bitstream to determine the quantization parameters of a transcoded bitstream. The quantization parameters of one or more macroblocks of a source bitstream are used to determine the quantization parameter of a transcoded macroblock. Embodiments feature low computational complexity, especially at the macroblock processing level, and can be applied in systems having long processing pipelines because no macroblock level feedback loop is required.

Embodiments compute a quantization parameter of a transcoded macroblock by multiplying an average of quantization parameters of a set of source bitstream macroblocks, from which a transcoded macroblock is derived, by a multiplier value. The multiplier value is updated on a frame by frame basis.

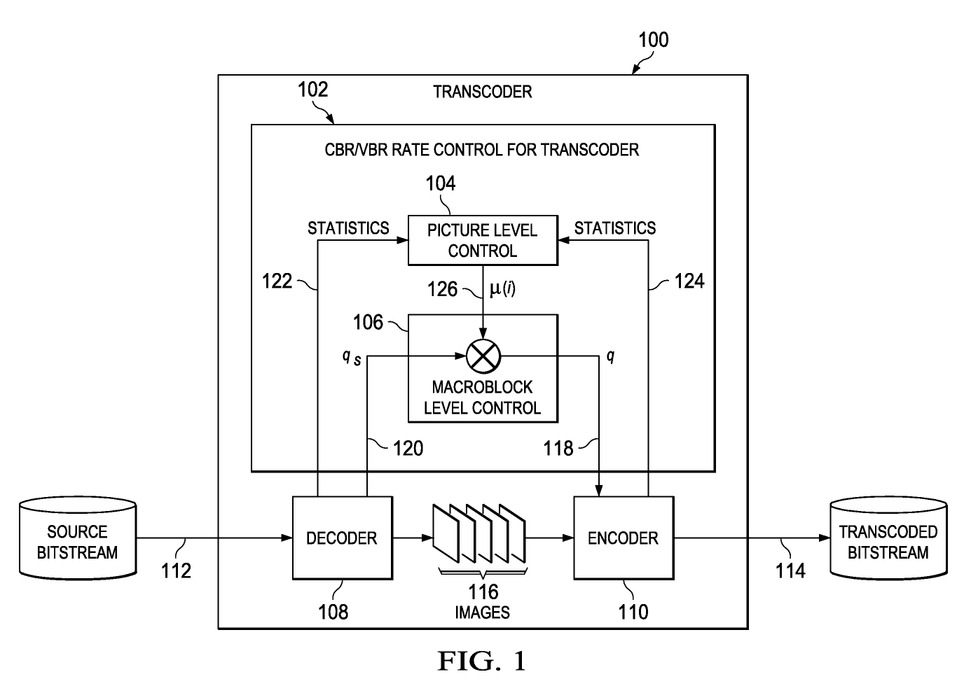

FIG. 1 shows an exemplary transcoder 100 in accordance with various embodiments. The video bitstream 112 provided to the transcoder 100 can be derived from any number of sources, for example, video data broadcast over the air by terrestrial or satellite transmitter, video data transmitted through a cable television system or over the internet, or video data read from a storage medium, such as a digital video disk (“DVD”), a Blu-Ray Disk®, a digital video recorder, etc.

The video data contained in the video bitstream 112 can be encoded in one of a variety of formats, for example, MPEG-2 or H.264. Furthermore, the encoded data can meant for display at one of several resolutions (e.g., 1280×720 (“720 p”) or 1920×1080 (“1080i” or “1080p”), and/or provided at a bitrate that may be inappropriate for some display devices.

The transcoder 100 produces a transcoded video bitstream 114 containing image data derived from the video bitstream 112 encoded in a different format and/or provided at a different bitrate and/or prepared for display at a different video resolution. Thus, the transcoder 100 allows for display of video on a device that is incompatible with the video bitstream 112.

The transcoder 100 includes a decoder 108, an encoder 110, and rate controller 102. The decoder 108 decompresses (i.e., decodes) the video bitstream 112 to provide a set of video images 116. The encoder 110 analyzes and codes the images 116 in accordance with a selected coding standard (e.g., H.264), and/or bitrate and/or display resolution (e.g., 640×480 “VGA”) to construct the transcoded bitstream 114. In some embodiments, the encoder 110 can include motion prediction, frequency domain transformation (e.g., discrete cosine transformation), quantization, and entropy coding (e.g., Huffman coding, content adaptive variable length coding, etc.).

Embodiments of the rate controller 102 compute quantization parameters 118 that are provided in the encoder 110 to facilitate compression of the data contained in the transcoded bitstream 114. The rate controller 102 comprises a picture (i.e., frame) level controller 104, and a macroblock level controller 106. The picture level controller 104 processes statistical information 122 derived from the decoder 108 and statistical information 124 derived from the encoder 110 to produce a quantizer scaling value 126. Examples of the statistical information employed include an estimate of the average coded bit count of the video bitstream 112, the target average bitrate, pixels in a video bitstream 112 picture, and bits and pixels in a transcoded bitstream 114 picture. A scaling value 126 is generated for each picture and provided to the macroblock level controller 106.

The macroblock level controller 106 determines a quantization parameter 118 for each macroblock of the transcoded bitstream 114. Embodiments of the macroblock level controller take advantage of quantization parameters provided in the video bitstream 112 to improve the quality of the transcoded video. More specifically, quantization parameters 120 associated with one or more macroblocks in the video bitstream 112 that contribute to a transcoded macroblock are processed to generate the quantization parameter 118 for the corresponding transcoded macroblock. The macroblock level controller 106 multiplies the video bitstream 112 macroblock quantization parameter 120 corresponding to the macroblock being transcoded with the scaling value 126 to produce the quantization parameter 118. Thus, at the macroblock processing level, embodiments of the rate controller 102 substantially reduce processing by considering only the quantization parameters 120 extracted from the video bitstream 112 and the scaler value 126 to generate the quantization parameter 118.

The transcoder 100 can be implemented as processor, for example, a digital signal processor, microprocessor, microcontroller, etc., executing a set of software modules stored in a processor readable medium (e.g., semiconductor memory) that configure the processor to perform the rate control functions described herein, or as dedicated circuitry configured to provide the disclosed rate control functions, or as a combination of a processor, software, and dedicated circuitry. In one embodiment, a processor and associated software implement the picture level controller 104, and dedicated circuitry implements the macroblock level controller 106. In another embodiment, both picture level and macroblock level controllers 104, 106 are implemented by a processor executing rate controller software. Embodiments of the present disclosure encompass all embodiments of transcoder 100 implementing rate controller 102 as described herein.

Embodiments of the transcoder 100, and included rate controller 102, are applicable to both constant bit rate (“CBR”) and variable bit rate (“VBR”) operation. CBR operation is detailed first below, followed by modifications to CBR operation that enable VBR operation.

Embodiments of the transcoder 100 are prepared for operation by initializing various system variables.

e(0)=0. (1)

initializes a balance (i.e., difference) between actual bit consumption and target bit consumption.

Sₚ(0)=0, and (2)

S_{b}(0)=0, (3)

initialize, respectively, the number of bits used to encode the last predictively coded picture (“P-picture”) and the last bi-predictively coded picture (“B-picture”).

Oᵢ(−1)=0, (4)

Oₚ(−1)=0 and (5)

O_{b}(−1)=0, (6)

initialize, respectively, the number of coded bytes of an input picture (intra coded picture (“I-picture”), predictively coded picture (“P-picture”), and bi-predictively coded picture (“B-picture”)).

$${K}_{p} = {k}_{p} max ( \frac{1}{{R}_{t}} , \frac{1}{B} ) , \qquad ( 7 )$$

derives the proportional gain Kₚ applied in computing the quantizer scaling value 126.
kₚ denotes a control parameter, and is set to 1 in some embodiments.
Rₜ represents the gain in terms of target bitrate in bits/second.
B represents the gain in terms of a reference buffer (e.g., hypothetical reference decoder, “HRD”) constraint, with the video buffering verifier (“VBV”)/HRD buffer size expressed in bits.

Before transcoding each picture (a frame picture or a field picture), various group of picture (“GOP”) parameters are preferably established. The GOP structure is estimated, if not known beforehand, and the established GOP structure is applied to produce an estimate of the balance at the end of the current GOP. Embodiments determine current frame location, estimate I/P frame interval, and estimate I-frame interval as part of GOP structure estimation.

In estimating a GOP structure, embodiments assume that each I-frame starts a new GOP for purposes of rate control. The estimation is performed in units of frames even if the bitstream includes field pictures. Embodiments consider I-P field pictures and I-I field pictures to be I-frames for purposes of GOP structure estimation.

Embodiments determine the current frame location in the current GOP in bitstream order.

n_{c}(i)=NumFrames+1, (8)

where NumFrames is the number of frames between the most recent I-frame and the current frame in bitstream order. If the current frame is an I-frame (or I-P or I-I field picture as noted above, i.e., the first frame in a GOP), then n_{c}(i) is set to zero.

Embodiments estimate the I/P frame interval.

[symbol]

(i)=IP_Displacement, (9)

where IP_Displacement is the number of frames between the most recent two I- or P-frames in display order. When there are not two different I- or P-transcoded frames (at the beginning of the transcoding), [symbol] (i) is set to two. Some coding format syntax elements such as MPEG-2 “temporal reference” (which indicates the position of a picture in display order within a GOP), or H.264 “POC” (picture order count) can be used to derive the estimate. If a change of I/P frame interval is detected (i.e., [symbol] (i)≠ [symbol] (i−1)) embodiments adapt to the change by resetting Sₚ(i) and S_{b}(i) to zero, and disabling Q ratio (i.e., quantizer scale value 126) update.

Embodiments estimate the I-frame interval (i.e., estimate the GOP size).

[symbol]

(i)=max (N_{II0}(i), N_{II1}(i), n_{c}(i)), (10)

where, N_{II0}(i) is one plus the number of frames between the most recent two I-frames, and N_{II1}(i) is one plus the number of frames between the second and third most recent I-frames. When N_{II0}(i) and/or N_{II1}(i) cannot be defined at the beginning of transcoding, N_{II0}(i) and/or N_{II1}(i) are set to 15.

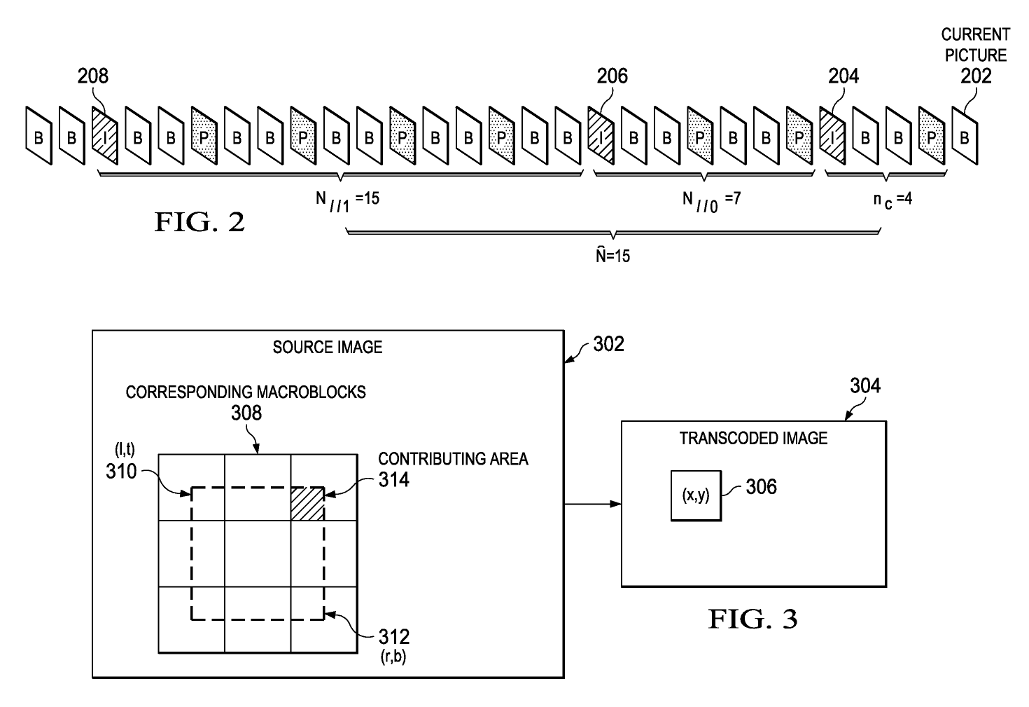

FIG. 2 shows an example of GOP size estimation in accordance with various embodiments. In FIG. 2, the current picture 202 is four frames from the previous I-frame 204, thus n_{c} is four. The two prior I-frames are seven frames apart, making N_{II0} equal to seven. The second and third prior I-frames 206, 208 are 15 frames apart, so N_{II1} is 15. Thus, equation (10) results in [symbol] (i) set to 15.

To reduce the fluctuation of bit allocation by the relative position in a GOP, embodiments estimate the balance at the end of the current GOP, and use the estimate rather than the actual balance, e(i). Embodiments estimate the number of P- and B-pictures remaining in a GOP.

$${n}^{⋒} ( i ) = 2 ( {N}^{⋒} ( i ) - {n}_{c} ( i ) ) + \{ \begin{matrix}- 1 & ( \begin{matrix}a second field of \\ a field picture\end{matrix} ) \\ 0 & ( otherwise ) ,\end{matrix} \qquad ( 11 )$$

estimates the number of remaining fields in the current GOP.

$${{n}^{⋒}}_{p} ( i ) = 2 \frac{( {N}^{⋒} ( i ) - {n}_{c} ( i ) )}{{M}^{⋒} ( i )} + \{ \begin{matrix}- 1 & a second field of a I or P field picture ) \\ 0 & ( otherwise ) ,\end{matrix} \qquad ( 12 )$$

estimates the number of P-fields remaining in the current GOP.

$${{n}^{⋒}}_{b} ( i ) = 2 ( {N}^{⋒} ( i ) - {n}_{c} ( i ) - {{n}^{⋒}}_{p} ( i ) ) + \{ \begin{matrix}- 1 & ( a second field of a B field picture ) \\ 0 & ( otherwise ) ,\end{matrix} \qquad ( 13 )$$

estimates the number of B-fields remaining in the current GOP.

Using the above field estimates, embodiments test the following three conditions. If any of the conditions are not met e(i) (actual balance) rather than ê(i) (estimated balance) becomes the operative value used to compute μ_{base} equation (25) below.
1) The current picture is not an I-picture (i.e., the current picture is not at the end of the previous GOP, so e(i) cannot be used without estimation).
2) Sₚ(i)≠0 [symbol] ₚ(i)>0.
3) S_{b}(i)≠0 [symbol] _{b}(i)>0.

If all of the above three conditions are fulfilled, balance estimation continues.

$${B}^{⋒} ( i ) = \frac{{R}_{t}}{2 f} {n}^{⋒} ( i ) \times \{ \begin{matrix}5 / 4 & ( 3 \text{:} 2 pulldown is detected ) \\ 1 & ( otherwise ) ,\end{matrix} \qquad ( 14 )$$

estimates the bit budget for the remaining frames or fields in the current GOP, where f denotes the frame rate in frames per second (“fps”). 3:2 pulldown status of a source bitstream is determined by finding that the number of display fields is 3, 2, 3, 2, . . . .

$${S}^{⋒} ( i ) = \frac{{S}_{p} ( i ) \cdot {{n}^{⋒}}_{p} ( i )}{2} + \frac{{S}_{b} ( i ) \cdot {{n}^{⋒}}_{b} ( i )}{2} , \qquad ( 15 )$$

estimates the bit consumption of the remaining frames or fields in the current GOP.

[symbol]

(i)=e(i)+ [symbol] (i)− [symbol] (i), (16)

estimates the balance at the end of the current GOP.

Embodiments estimate the bitrate of the input bitstream 112, to provide stable operation even when the input bitstream 112 is compressed using a variable bitrate. Equations (17)-(18) below update the byte counts of the input bitstream 112.

$$\begin{matrix}O ( i ) = the number of coded bytes for i \text{-} th input picture \times \{ \begin{matrix}1 & ( frame picture ) \\ 2 & ( field picture ) ,\end{matrix} & ( 17 ) \\ {O}_{x} ( i ) = \{ \begin{matrix}O ( i ) & ( x = coding type ⋀ {O}_{x} ( i ) = 0 ) \\ γ O ( i ) + ( 1 - γ ) {O}_{x} ( i - 1 ) & ( x = coding type ⋀ {O}_{x} ( i ) \neq 0 ) \\ {O}_{x} ( i - 1 ) & ( otherwise ) ,\end{matrix} & ( 18 )\end{matrix}$$

where, x is i, p or b for the input picture coding type of I-, P- or B-picture, respectively. γ is a pre-determined parameter to control the speed of averaging process, and γ is set to ⅛ in some embodiments.

$${{N}^{⋒}}_{p} ( i ) = \frac{{N}^{⋒} ( i )}{\breve{M} ( i )} - 1 , \qquad ( 19 )$$

where [symbol] (i) and [symbol] (i) are as defined above, estimates the number of P-frames in the current GOP.

[symbol]

_{b}(i)= [symbol] (i)−1− [symbol] hd p(i), (20)

estimates the number of B-frames in the current GOP.

$${r}_{s} ( i ) = \frac{{O}_{i} ( i ) + {{N}^{⋒}}_{p} ( i ) {O}_{p}^{′} ( i ) + {{N}^{⋒}}_{b} ( i ) {O}_{b}^{′} ( i )}{{N}^{⋒} ( i )} / 2 \times 8 , \qquad ( 21 )$$

where rₛ(i) is an estimate of the average coded bit count of the input bitstream 112 in bits/field,

$$\begin{matrix}{O}_{p}^{′} ( i ) = \{ \begin{matrix}{O}_{p} ( i ) & ( {O}_{p} ( i ) \neq 0 ) \\ \frac{3}{8} {O}_{i} ( i ) & ( {O}_{p} ( i ) = 0 )\end{matrix} , and & ( 22 ) \\ {O}_{b}^{′} ( i ) = \{ \begin{matrix}{O}_{b} ( i ) & ( {O}_{b} ( i ) \neq 0 ) \\ \frac{1}{2} {O}_{p}^{′} ( i ) & ( {O}_{b} ( i ) = 0 ) .\end{matrix} & ( 23 )\end{matrix}$$

The estimates of byte counts for missing P- and B-pictures assumes MPEG-2 coding. Embodiments apply different coefficients when different coding is used.

Embodiments apply the average coded bit count estimate, rₛ(i), of equation (21) to derive a quantization multiplier μ₀.

$${μ}_{0} ( i ) = \frac{{r}_{s} ( i )}{{r}_{t}} \times \frac{{A}_{t}}{{A}_{s}} , \qquad ( 24 )$$

where, r₁ denotes the target average bitrate in bits/field, Aₛ denotes the number of pixels in a frame of the source bitstream and Aₜ denotes the number of pixels in a frame of the transcoded bitstream (Aₛ can differ from Aₜ when transcoding accompanies a change of spatial resolution).

Using the quantization multiplier μ₀ of equation (24), embodiments compute an update of the quantizer scaling value 126 (i.e., a Q ratio). The Q ratio 126 is applied to all macroblocks of the current picture. A final Q ratio 126 applied to each block is determined based on picture coding type. For example, in some embodiments, the Q ratio may be smaller for I-pictures and/or P-pictures than for B-pictures. This adjustment is based on the observation that I- and P-pictures tend to degrade faster than B-pictures. If the estimation process described above in equations (14)-(16) is skipped, the actual balance e(i) is used in equation (25) instead of the estimated balance [symbol] (i).

$$\begin{matrix}{μ}_{base} ( i ) = {μ}_{0} ( i ) \times ( 1 + {K}_{p} {e}^{⋒} ( i ) ) , & ( 25 ) \\ μ ( i ) = \{ \begin{matrix}\frac{5 {μ}_{base} ( i ) + 3}{8} & ( I \text{-} pictures ) \\ {μ}_{base} ( i ) & ( P \text{-} pictures ) \\ \frac{12 {μ}_{base} ( i ) - 4}{8} & ( B \text{-} pictures )\end{matrix} & ( 26 )\end{matrix}$$

Embodiments of the macroblock level controller 106 derive a quantization parameter for a macroblock in position (x,y) in the i-th picture by multiplying the Q ratio 126 of the picture with the weighted average of the quantization parameters 120 of the corresponding macroblocks in the source bitstream 112. The definition of the quantization parameter 118 depends on the compression standard employed. For H.264, the relationship between Qp and the quantization parameter q 118 is defined as:

$$q = {2}^{\frac{Qp - 4}{6}} . \qquad ( 27 )$$

For MPEG, q=quantizer_scale as defined in the MPEG specification. For VC-1, q=double_quant as defined in the VC-1 specification.

q(i, x, y)=μ(i)· q̅ₛ(i, x, y), (28)

where q(i,x,y) denotes the quantization parameter 118 to be applied to the macroblock and q̅ₛ(i,x,y) denotes the weighted average quantization parameter for the macroblock that is defined as follows:
For 1:1 correspondence:

q̅ₛ(i, x, y)=qₛ(i, x, y), (29)

where qₛ(i,x,y) is the quantization parameter of the macroblock in position is (x, y) in the i-th picture of the source bitstream (that is, the collocated macroblock in this case).
For 2:1 correspondence:

$${\overline{q}}_{s} ( i , x , y ) = \frac{{q}_{s} ( i , {x}_{0} , {y}_{0} ) + {q}_{s} ( i , {x}_{1} , {y}_{1} )}{2} . \qquad ( 30 )$$

Equation (30) applies for a macroblock in a field macroblock pair when performing MPEG-2 to H.264 transcoding without a change of resolution. In such a case, some embodiments use the following values:

$$\{ \begin{matrix}{x}_{0} = x \\ {x}_{1} = x \\ {y}_{0} = 2 ⌈ y / 2 ⌉ \\ {y}_{1} = 2 ⌈ y / 2 ⌉ + 1\end{matrix}$$

Equation (30) also applies when transcoding with horizontal 2:1 resealing. For this case, some embodiments use the following values:

$$\{ \begin{matrix}{x}_{0} = 2 x \\ {x}_{1} = 2 x + 1 \\ {y}_{0} = y \\ {y}_{1} = y\end{matrix}$$

In general, embodiments compute a weighted average of source bitstream macroblock quantization parameters as:

$${\overline{q}}_{s} ( i , x , y ) = \frac{{\sum }_{( m , n ) ∈ M ( x , y )} {q}_{s} ( i , m , n ) {a}_{m , n}}{{\sum }_{( m , n ) ∈ M ( x , y )} {a}_{m , n}} , \qquad ( 31 )$$

where M and a are as defined below.

Each transcoded macroblock corresponds to one or more source macroblocks. Macroblock correspondence depends, at least in part, on the transcoding operations being performed. When downsampling a source image, for example from 1080i to 480i, each macroblock of the transcoded image corresponds to a larger portion of the source image than does a source macroblock (i.e., the transcoded macroblock comprises more than one source macroblocks). The location of the source pixels corresponding to the transcoded macroblock is derived as:

$$\begin{matrix}l = ⌊ 16 x \cdot \frac{{w}_{o}}{w} ⌋ , & ( 32 ) \\ r = ⌊ ( 16 x + 15 ) \cdot \frac{{w}_{o}}{w} ⌋ , & ( 33 ) \\ t = \{ \begin{matrix}⌊ 16 y \cdot \frac{{h}_{o}}{h} ⌋ & ( frame macroblock ) \\ ⌊ 16 {y}^{′} \cdot \frac{{h}_{o}}{h} ⌋ & ( field macroblock ) ,\end{matrix} & ( 34 ) \\ b = \{ \begin{matrix}⌊ ( 16 y + 15 ) \cdot \frac{{h}_{o}}{h} ⌋ & ( frame macroblock ) \\ ⌊ ( 16 {y}^{′} + 31 ) \cdot \frac{{h}_{o}}{h} ⌋ & ( field macroblock )\end{matrix} , and & ( 35 ) \\ {y}^{′} = 2 ⌊ \frac{y}{2} ⌋ , & ( 36 )\end{matrix}$$

where w and h are the width and height of the transcoded image, w₀ and h₀ are the width and height of the source image, and (l,t) and (r,b) define the left-top and bottom-right positions of a rectangle of source image pixels corresponding to the transcoded macroblock. FIG. 3 shows an exemplary source image 302 and a exemplary transcoded image 304. The transcoded image 304 includes a transcoded macroblock 306. The transcoded macroblock 306 is derived from portions of corresponding macroblocks 308 of the source image 302. Any source macroblock containing at least one pixel within the rectangle defined by (l,t) 310 and (r,b) 312 is considered a corresponding macroblock of the transcoded macroblock 306. Formally, the set of corresponding macroblocks, M, is defined as:

$$\begin{matrix}M = \{ ( X , Y ) \vert {x}_{l} \leq X \leq {x}_{r} , {y}_{t} \leq Y \leq {y}_{b} \} , & ( 37 ) \\ {x}_{l} = ⌊ \frac{l}{16} ⌋ , {x}_{r} = ⌊ \frac{r}{16} ⌋ , {y}_{t} = ⌊ \frac{t}{16} ⌋ , {y}_{b} = ⌊ \frac{b}{16} ⌋ . & ( 38 )\end{matrix}$$

Not all of the pixels in a corresponding macroblock actually relate to the transcoded macroblock. In order to appropriately treat this fact, embodiments use “contributing area” 314, which is defined as the number of pixels in a corresponding macroblock 308 that relate to the transcoded macroblock 304. Contributing area 314, a, of a corresponding macroblock (X, Y) 308 is defined, in at least some embodiments, as:

a_{X,Y}=[min(16X+15,r)−max(16X,l)+1]·[min(16Y+15,b)−max(16Y,t)+1] (39)

When not downsampling, for example, when transcoding from 1080i to 1080i or 720p to 720p, w=w₀ and h=h₀. Under these conditions,

$$\begin{matrix}{x}_{l} = x , & ( 40 ) \\ {x}_{r} = x , & ( 41 ) \\ {y}_{t} = \{ \begin{matrix}y & ( frame macroblock ) \\ {y}^{′} & ( field macroblock )\end{matrix} , and & ( 42 ) \\ {y}_{b} = \{ \begin{matrix}y & ( frame macroblock ) \\ {y}^{′} + 1 & ( field macroblock ) .\end{matrix} & ( 43 )\end{matrix}$$

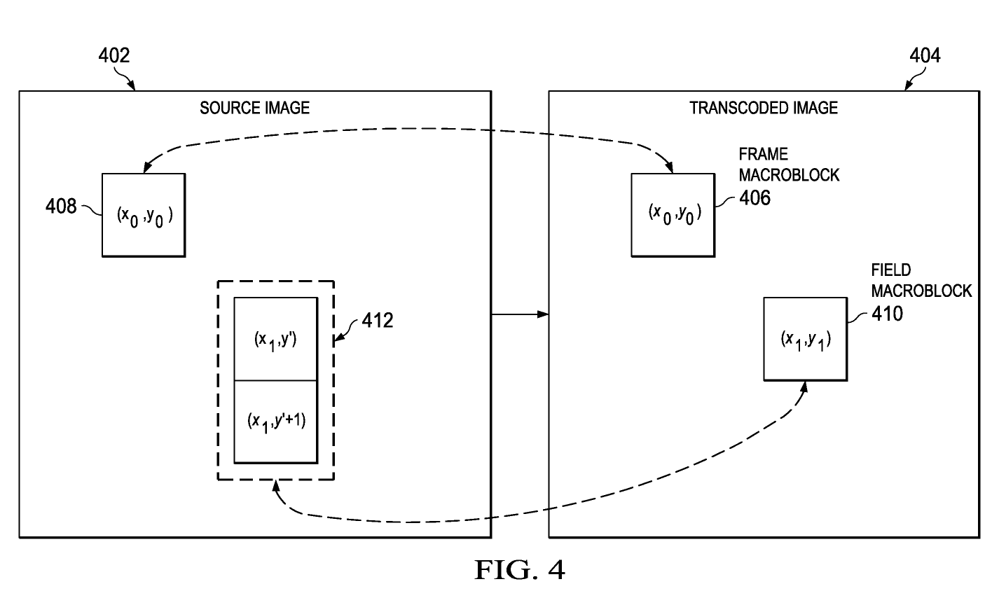

FIG. 4 shows an exemplary source image 402 and transcoded image 404. Transcoded frame block 406 corresponds to one co-located macroblock 408 of the source image 402. Transcoded field macroblock 410 corresponds to two vertically adjacent macroblocks 412 in the source image 402. The contributing area of each corresponding macroblock is 256 in embodiments employing 16×16 pixel macroblocks.

In the case of 1080i to horizontally halved 1080i transcoding, w=w₀/2 and h=h₀. Under these conditions,

$$\begin{matrix}{x}_{l} = 2 x , & ( 44 ) \\ {x}_{r} = 2 x + 1 , & ( 45 ) \\ {y}_{t} = \{ \begin{matrix}y & ( frame macroblock ) \\ {y}^{′} & ( field macroblock )\end{matrix} , and & ( 46 ) \\ {y}_{b} = \{ \begin{matrix}y & ( frame macroblock ) \\ {y}^{′} + 1 & ( field macroblock ) .\end{matrix} & ( 47 )\end{matrix}$$

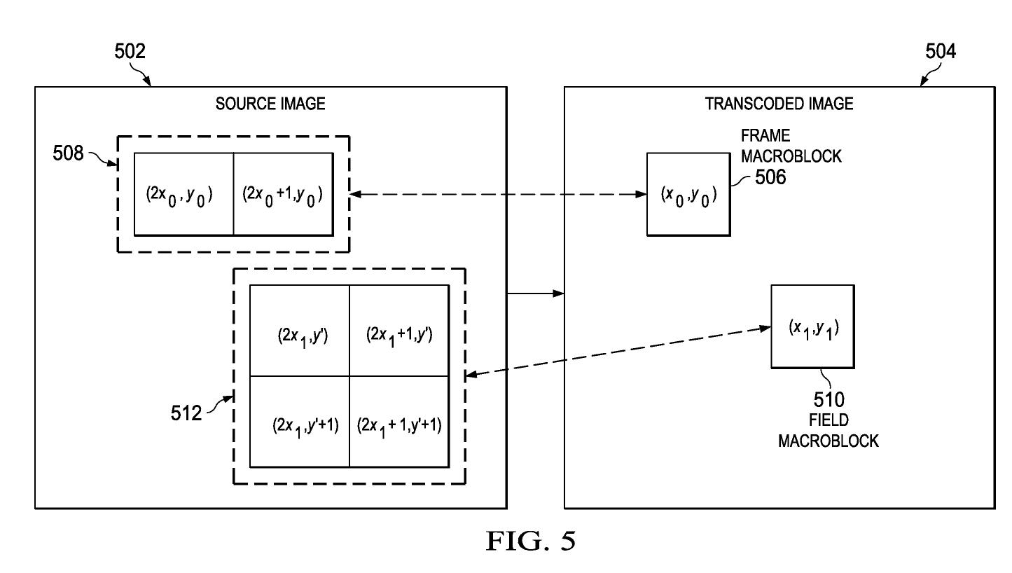

FIG. 5 shows an exemplary source image 502 and horizontally halved trancoded image 504 derived from the source image 502. A frame macroblock 506 in transcoded image 504 corresponds to a 2×1 macroblock rectangle 508 in the source image 502. A field macroblock 510 corresponds to a 2×2 macroblock rectangle 512 in the source image 502. The contributing area of each source macroblock is 256 in embodiments employing 16×16 pixel macroblocks.

After completion of picture (i.e., frame or field picture) transcoding, embodiments update various transcoding parameters including balance and bits consumed by recently transcoded pictures.

$$e ( i + 1 ) = max ( - B , e ( i ) + S ( i ) - \frac{{R}_{t}}{f} \cdot \frac{d ( i )}{2} ) , \qquad ( 48 )$$

updates the balance, where S(i) denotes the actual number of bits used in the i-th picture, and d(i) denotes the display duration of the picture in units of one-field-period. B is the VBV/HRD buffer size and is used to prevent too large a carry over; this is necessary for situations where an input sequence is extremely easy to encode, for example, a black screen.

The number of bits used to encode recent pictures is updated as:

$$\begin{matrix}{S}_{p} ( i + 1 ) = \{ \begin{matrix}{S}^{′} ( i ) & ( i \text{-} th picture is P \text{-} picture ⋀ {S}_{p} ( i ) = 0 ) \\ β {S}^{′} ( i ) + ( 1 - β ) {S}_{p} ( i ) & ( i \text{-} th picture is P \text{-} picture ⋀ {S}_{p} ( i ) > 0 ) \\ {S}_{p} ( i ) & ( otherwise ; i \text{-} th picture is not P \text{-} picture ) ,\end{matrix} & ( 49 ) \\ {S}_{b} ( i + 1 ) = \{ \begin{matrix}{S}^{′} ( i ) & ( i \text{-} th picture is B \text{-} picture ⋀ {S}_{b} ( i ) = 0 ) \\ β {S}^{′} ( i ) + ( 1 - β ) {S}_{b} ( i ) & ( i \text{-} th picture is B \text{-} picture ⋀ {S}_{b} ( i ) > 0 ) \\ {S}_{b} ( i ) & ( otherwise ; i \text{-} th picture is not B \text{-} picture ) ,\end{matrix} \\ and & ( 50 ) \\ {S}^{′} ( i ) = \{ \begin{matrix}S ( i ) & ( i \text{-} th picture is a frame picture ) \\ 2 S ( i ) & ( i \text{-} th picture is a field picture ) ,\end{matrix} & ( 51 )\end{matrix}$$

where β is a pre-determined parameter to control the speed of the averaging process, and it is set to ¼ in at least some embodiments.

The foregoing description is generally applicable to transcoder embodiments providing CBR video streams. Transcoder embodiments providing VBR operation can be implemented by adapting the above-described CBR methodology as set forth below.

At the start of VBR transcoding, statistical parameters related to the VBR algorithm are preferably initialized. Initialized VBR parameters include target bit rate, global complexity measure, initial buffer occupancy, and bits used. Statistical parameters related to the CBR algorithm are preferably initialized as described above in equations (1)-(7) and associated text.

The target (i.e., the desired) bit-budget for a picture r(i) is initialized as:

$$r ( 0 ) = {r}_{0} = \frac{{R}_{T}}{2 f} \qquad ( 52 )$$

where R_{T} denotes the target average bitrate in units of bits-per-second (“bps”), and f denotes the frame rate in units of frame-per-second (“fps”). r(i) represents a momentary target bit-budget for rate control. The value of r(i) will be increased if the input pictures are more complex than the average. A method for updating r(i) is explained below.

Global complexity measure (“GCM”) is employed to control target bitrate in accordance with the complexity of the target pictures. Both GCM, Xₓ(i): x ∈ {I,P,B}, and average GCM, X̅ₓ(i):x ∈ {I,P,B}, initialization values are shown in Table 1 below. A method of updating picture complexity is explained below.

X̅ₓ(0)=Xₓ(0): x ∈ {I, P, B} (53)

TABLE 1
Initial GCM Values

| | Picture Size | | | | |
|---|---|---|---|---|---|
| | | | 720 × 480 | | |
| Initial Value | 1920 × 1080 | 1440 × 1080 | 704 × 480 | 352 × 480 | 352 × 240 |
| X_{I}(0) | 17.7 × 10⁶ | 13.3 × 10⁶ | 4 × 10⁶ | 2 × 10⁶ | 1 × 10⁶ |
| X_{P}(0) | 8.53 × 10⁶ | 6.4 × 10⁶ | 2 × 10⁶ | 1 × 10⁶ | 0.5 × 10⁶ |
| X_{B}(0) | 5.82 × 10⁶ | 4.4 × 10⁶ | 1.5 × 10⁶ | 0.75 × 10⁶ | 0.375 × 10⁶ |

Buffer occupancy (i.e., fullness) b(i) is specified in terms of the VBV buffer of MPEG-2 or the HRD buffer of H.264. The initial value of the parameter is

b(0)=B (54)

where B denotes the maximum size of the VBV buffer or HRD buffer in bits.

Balance of the number of bits used up to i-th picture, Δ(i), is initialized as:

Δ(0)=0 (55)

After each picture is encoded, embodiments of the VBR transcoder use Δ(i) to provide a new target bit budget r(i). A method of updating Δ(i) is explained below.

As in CBR transcoding, embodiments of a VBR transcoder perform various operations prior to transcoding each picture. In at least some embodiments, the balance update performed at the end of a GOP and/or the base quantization multiplier update can be different from those performed in CBR encoding.

GOP structure estimation for a VBR transcoder is preferably the same as for the CBR transcoder as described above in equations (8)-(10) and associated text.

The balance at completion of GOP processing is preferably estimated as described above in equations (11)-(16) and associated text, with the exception that equation (14) is replaced with equation (56) below that uses r(i) rather than r(0) to compute the bit budget \hat{B}(i).

$$\hat{B} ( i ) = r ( i ) \cdot \hat{n} ( i ) \times \{ \begin{matrix}5 / 4 & ( 3 \text{:} 2 pulldown is detected ) \\ 1 & ( otherwise )\end{matrix} \qquad ( 56 )$$

Input bit rate estimation for a VBR transcoder is preferably the same as described above in equations (17)-(23) and associated text with regard to the CBR transcoder.

Embodiments of a VBR transcoder preferably employ equation (57) below rather than equation (24), used by the CBR transcoder, to update the base quantization multiplier, μ₀(i). Equation (57) replaces rₜ with r(i).

$${μ}_{0} ( i ) = \frac{{r}_{s} ( i )}{r ( i )} \times \frac{{A}_{t}}{{A}_{s}} \qquad ( 57 )$$

Q ratio update computation for embodiments of a VBR transcoder is preferably the same as for the CBR transcoder, as described above in equations (25)-(26) and associated text.

Quantization parameter derivation for embodiments of a VBR transcoder is preferably the same as for the CBR transcoder, as described above in equations (27)-(31) and associated text.

After each picture is transcoded and before CBR parameters are updated, various VBR related parameters are preferably updated. The VBR related parameters updated can include GCM, buffer occupancy, and target bit budget.

The GCM value for the picture type of a last processed picture is updated as:

$${X}_{x} ( i + 1 ) = \{ \begin{matrix}S ( i ) \cdot \overline{Q} ( i ) & ( x is equal to current picture type ) \\ {X}_{x} ( i ) & ( otherwise )\end{matrix} \qquad ( 58 )$$

where Q̅(i) is the average value of the quantizer scaler, q, 118 for the picture. The average value of GCM is calculated by the following equation. The infinite impulse response (“IIR”) style is used to simplify the implementation.

$$\overline{{X}_{x}} ( i + 1 ) = \{ \begin{matrix}( 1 - α ) \cdot {\overline{X}}_{x} ( i ) = α \cdot {X}_{x} ( i + 1 ) & ( x is equal to current picture type ) \\ {\overline{X}}_{x} ( i ) & ( otherwise )\end{matrix} α = \frac{1}{{2}^{10}} \qquad ( 59 )$$

where x is i, p or b for the picture coding type of I-, P- or B-picture, respectively.

Buffer occupancy status is updated as:

b(i+1)=min(b(i)+r₀·d(i)−S(i), B) (60)

The VBR target bit budget is updated via a series of operations including updating the base target bit budget estimate, adjusting the target bit budget in accordance with upper and lower limits, and adjusting for buffer occupancy.

In the base target bit budget estimate, the balance of the bits, Δ(i), is updated as:

Δ(i+1)=Δ(i)+r₀·d(i)−S(i) (61)

where d(i) denotes the display duration of the picture in field period units.

The base bit-budget r_{base}(i) is proportional to the GCM value of the pictures. The base bit-budget r_{base}(i) for the next picture is calculated as:

$${r}_{base} ( i + 1 ) = \frac{{\sum }_{t ∈ \{ I , P , B \}} {\hat{n}}_{t} {X}_{t} ( i + 1 )}{{\sum }_{t ∈ \{ I , P , B \}} {\hat{n}}_{t} {\overline{X}}_{t} ( i + 1 )} \cdot ( {r}_{0} - \frac{Δ ( i + 1 )}{{2}^{L}} ) \qquad ( 62 )$$

where L is a parameter that determines a number of frames over which the bit budget is adjusted to compensate for prior excess or deficient bit use. In at least some embodiments, L is set to 14.

Embodiments constrain the target bit budget to upper and lower limits to avoid quality degradation and buffer underflow. When a picture is easy to encode, the base target budget for the picture tends to be smaller than the typical budget for other pictures because the GCM value of the picture is less than that of the other pictures. This situation sometimes causes subjective quality degradation because such quality degradation is more noticeable in such an easy to encode picture.

To avoid such quality degradation, a lower limit is applied to the target bitrate. In addition, the upper-limit for the target bitrate helps to avoid VBV or HRD buffer underflow. The lower and upper limits are preferably set as:

$$\begin{matrix}{r}_{min} ( i + 1 ) = η \cdot \frac{{R}_{T}}{2 f} , and & ( 63 ) \\ {r}_{max} ( i + 1 ) = \frac{{R}_{max}}{2 f} , & ( 64 )\end{matrix}$$

where η is a coefficient setting the minimum bitrate relative to the target bitrate, and Rₘₐₓ denotes the maximum bitrate provided by the transcoder 100. In at least some embodiments, η is set to 0.8.

Applying rₘᵢₙ and rₘₐₓ, the modified target rate r(i) is obtained as the following clip-operation:

r(i+1)=min(max(r_{base}(i+1), rₘᵢₙ(i+1)), rₘₐₓ(i+1)). (65)

Embodiments can apply the following averaging operation to r(i) to moderate target rate change.

$$r ( i + 1 ) = \frac{r ( i ) + ( γ - 1 ) \cdot r ( i + 1 )}{γ} , \qquad ( 66 )$$

where γ is a pre-determined parameter that controls the speed of averaging process. In at least some embodiments, γ is set to 8.

Some embodiments adjust r(i) in accordance with buffer occupancy to suppress underflow of the VBV or HRD buffer. As the VBV/HRD buffer occupancy gets lower (i.e., the buffer becomes less full), the target budget can be gradually reduced by using this modification.

$$r ( i + 1 ) = r ( i + 1 ) \cdot \frac{b ( i + 1 )}{B} \qquad ( 67 )$$

Embodiments of a VBR transcoder apply equation (68) below rather than equation (48) to update balance. Equation (68) uses r(i) rather than Rₜ.

e(i+1)=max(−B,e(i)+S(i)−r(i+1)·d(i)) (68)

The number of bits used for recently processed pictures in a VBR transcoder, is preferably updated in the same manner as described above for a CBR transcoder in equations (49)-(51). In some VBR transcoder embodiments, β in equation (50) is set to ½.

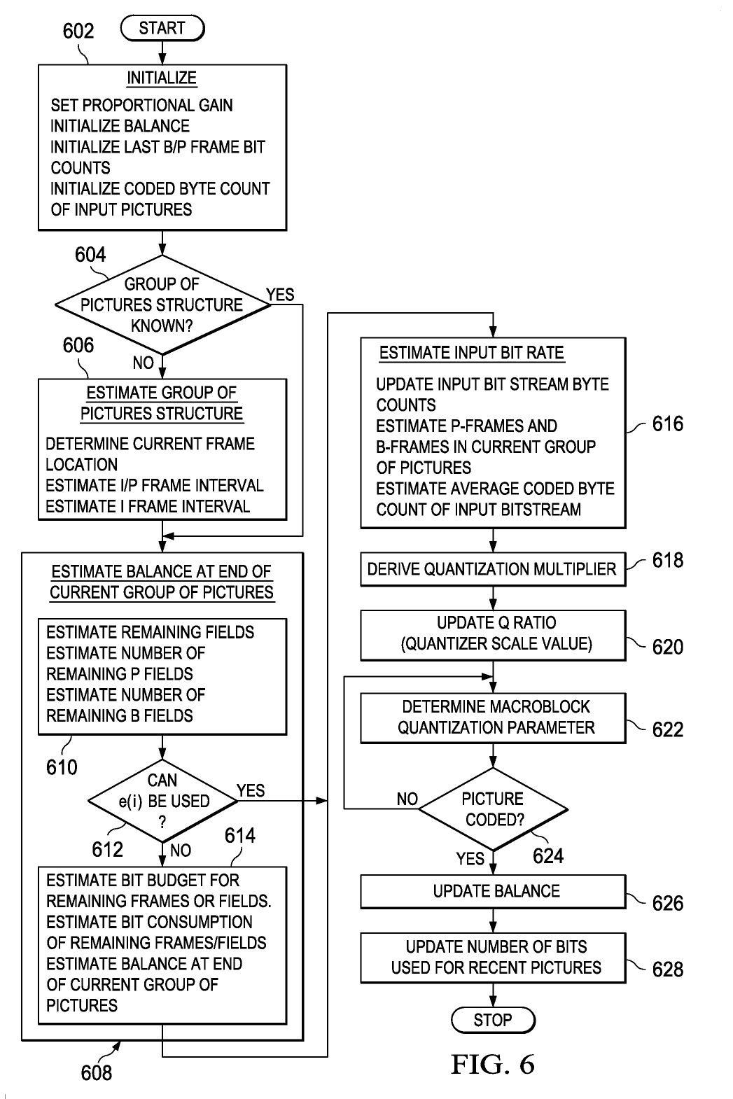

FIG. 6 shows a flow diagram for a method for CBR rate control in a transcoder 100 in accordance with various embodiments. Though depicted sequentially as a matter of convenience, at least some of the actions shown can be performed in a different order and/or performed in parallel. Additionally, some embodiments may perform only some of the actions shown.

Transcoding begins with initialization, by the rate controller 102, in block 602. Proportional gain is set as a scaled maximum of a target bit rate and a reference buffer size per equation (7) above. Balance between actual and target bit consumption, the number of bits used to encode the last P/B frames, and the number of coded bytes of I/P/B input pictures are zeroed.

The picture controller 104 begins picture level processing in block 604. If the structure of a GOP, including the picture currently being processed, is known, then processing continues in block 608 using the actual GOP structure information, otherwise the structure of the GOP is estimated in block 606. GOP structure estimation assumes that every I-frame starts a new GOP. Estimation is performed in frame units even if the input bitstream 112 includes field pictures. I-P field pictures and I-I field pictures are considered I-frames for purposes of GOP structure estimation.

GOP structure estimation, in block 606, includes determining the current frame location, estimating I/P frame interval, and estimating I-frame interval. Determining the current frame location comprises determining, in bitstream order, the location of the current frame in the GOP. The current location is denoted as one plus the number of frames between the last I-frame and the current frame. If the current frame is an I-frame, then the current location is set to zero.

The I/P frame interval is estimated as the number of frames, in display order, between the most recent two I- and P- frames. At the start of transcoding, before two I/P frames are transcoded, some embodiments set the interval to two. In some embodiments, MPEG-2 “temporal reference,” or H.264 “POC” can be used to derive the estimate.

The I-frame interval (i.e., the GOP size) is estimated as the maximum of the current frame location, the number or frames between the two most recent I-frames (15 if undefined), and the number of frames between the second and third most recent I-frames (15 if undefined).

Using the GOP structure estimate of block 606 or the actual GOP structure, the balance at the end of the current GOP is estimated in block 608. The balance estimate is used, in some cases, rather than the actual balance to reduce bit allocation fluctuations.

In block 610, the number of remaining P-fields, B-fields, and fields in toto are estimated. However, in block 612, if the current picture is not an I-picture, or the number of bits used to encode the last B-frame is non-zero and the GOP includes further B-fields, or number of bits used to encode the last P-frame is non-zero and the GOP includes further P-fields then actual balance, e(i), rather estimated balance can be used in block 616, and embodiments can discontinue the operations of block 608.

If the balance estimate is to be used, the estimation continues in block 614. The bit budget for the remaining frames and/or fields of the current GOP is estimated. The bit consumption of the remaining frames and/or fields of the current GOP is estimated, and used in conjunction with current actual balance and estimated remaining bit budget to compute an estimated balance at the end of the current GOP.

In block 616, the bitrate of the input bitstream 112 is estimated. The estimation includes updating the input bitstream byte counts, estimating the number of P-frames and B-frames in the current GOP, and estimating the average coded bitrate of the input bitstream 112. Embodiments perform these operations in accordance with corresponding equations (17)-(23) above.

In block 618, the quantization multiplier of equation (24) is derived. The quantization multiplier incorporates ratios of the input bitstream 112 bit count to the target average bitrate, and pixels per frame of the transcoded bitstream 114 to pixels per frame of the input bitstream 112.

The quantizer scale value 126 (i.e., the Q ratio) applied to scale the quantization parameters of each macroblock of the picture currently being processed is determined in block 620. Embodiments apply equations (25)-(26) above to produce the scale value 126.

In block 622, a quantization parameter 118 is computed for each macroblock. The quantization parameter 118 comprises a weighted average of quantization parameters of source bitstream 112 macroblocks corresponding to a transcoded macroblock multiplied by the quantizer scale value 126 for the picture. Embodiments of the rate controller 102 derive the quantization parameter in accordance with equations (28)-(47) above.

Completion of picture macroblock coding is ascertained in block 624. If further macroblocks of a picture remain to be transcoded, the processing continues in block 622. If all macroblocks of the current picture have been processed, then post-picture parameter updates begin in block 626.

In block 626, embodiments of the rate controller 102 update balance for the next picture in accordance with equation (48) above.

In block 628, embodiments of the rate controller 102 update the number of bits consumed by recently transcoded pictures. At least some embodiments perform the updates as specified in equations (49)-(51) above.

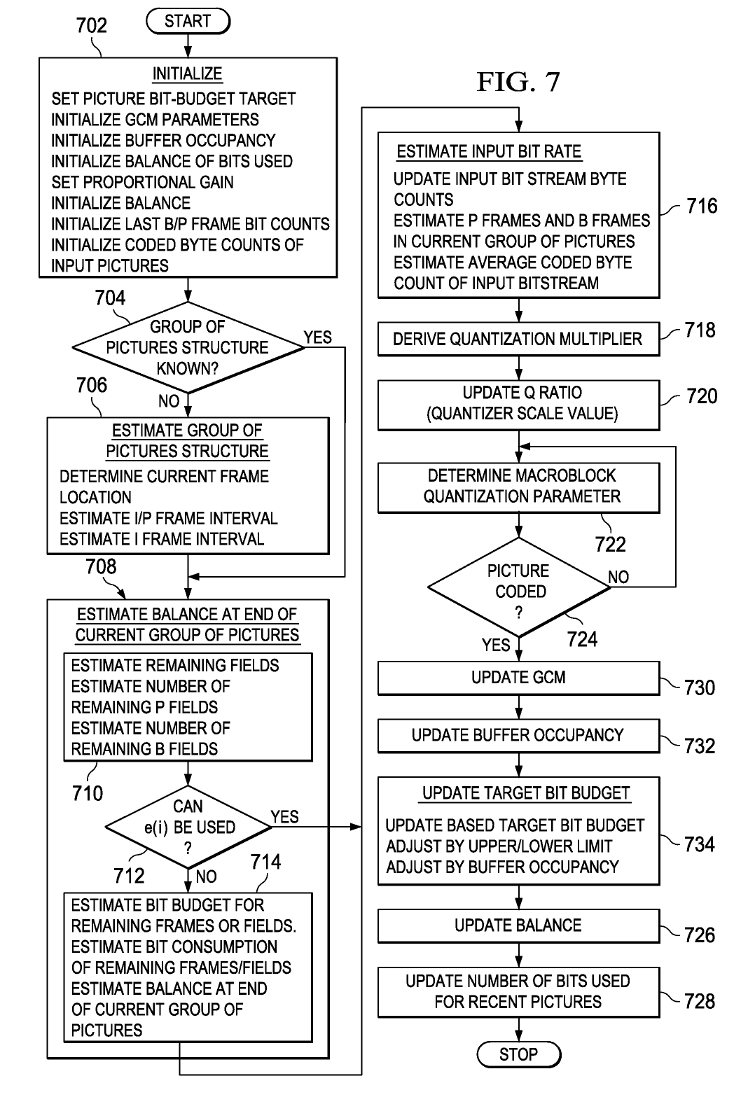

FIG. 7 shows a flow diagram for a method for VBR rate control in a transcoder 100 in accordance with various embodiments. Though depicted sequentially as a matter of convenience, at least some of the actions shown can be performed in a different order and/or performed in parallel. Additionally, some embodiments may perform only some of the actions shown. At least some operations of the VBR rate controller are based on the CBR rate controller operations described in FIG. 6.

Transcoding begins with rate controller 102 initialization in block 702. Various VBR statistical parameters used in transcoding are initialized, including the target bit budget for a picture, GCM parameters for each of I, P, and B pictures, buffer occupancy, and balance of bits used. VBR transcoding employs a variable target bit budget for a picture. Some embodiments initialize the bit budget in accordance with equation (52) above. GCM values for each picture type are initialized using a set of complexity values based, at least in part, on target picture size. For example, Table 2 above shows some values used to initialize picture type GCM values in some embodiments. Initial buffer occupancy is preferably set as a reference buffer (e.g., VBV or HRD) bit capacity. Balance of bits used in a picture is initialized to zero in some embodiments.

CBR related statistical parameters are also initialized. Proportional gain is preferably set as a scaled maximum of a target bit rate and a reference buffer size per equation (7) above. In some embodiments, balance between actual and target bit consumption, the number of bits used to encode the last P/B frames, and the number of coded bytes of I/P/B input pictures are zeroed.

The picture controller 104 begins picture level processing in block 704. If the structure of a GOP including the picture currently being processed is known, then processing continues in block 708 using the actual GOP structure information, otherwise the structure of the GOP is estimated in block 706. GOP structure estimation for VBR rate control is preferably the same as described above with regard to CBR rate control in block 606.

In block 708, the picture level controller 104, estimates the balance at the end of the current GOP. The operations performed to determine the estimate for the VBR rate controller are preferably the same as the operations performed for the CBR rate controller in block 608, except, as shown in equation (56), the VBR rate controller use r(i) to estimate the bit budget for the remaining frames/fields in the current GOP.

In block 716, the picture level controller 104 estimates the bitrate of the input bitstream 112. For a VBR rate controller, the estimate is preferably performed in accordance the CBR rate controller operations described in block 616.

In block 718, the quantization multiplier of equation (57) is derived. The VBR derivation is preferably similar to the CBR derivation of block 618, but employs r(i) rather than rₜ.

The quantizer scale value 126 (i.e., the Q ratio) applied to scale the quantization parameters of each macroblock of the picture currently being processed is determined in block 720. Embodiments of the VBR rate controller preferably apply the operations of block 620 (i.e., the CBR rate controller) to generate the scale value 126.

In block 722, a quantization parameter 118 is computed for each macroblock. The quantization parameter 118, for a VBR rate controller, is preferably computed as described with regard to block 622 for a CBR rate controller.

Completion of picture macroblock coding is ascertained in block 724. If further macroblocks of a picture remain to be transcoded, the processing continues in block 722. If all macroblocks of the picture have been processed, the post-picture parameter updates begin in block 730.

In block 730, the GCM value and average GCM value for the picture coding type (e.g., I/P/B picture types) of the last transcoded picture are updated. The operations of equations (58)-(59) are preferably performed to implement the GCM update.

Embodiments of the rate controller 102, when providing VBR rate control, update buffer occupancy status in block 732. The update is preferably performed in accordance with equation (60) above.

In block 734, the target bit budget applied to a picture is updated. The base target bit budget for a picture is updated as a proportion of the GCM values for the pictures. Some embodiments constrain the bit budget between upper and lower bounds to avoid buffer underflow and picture quality degradation. Buffer occupancy is preferably applied to suppress reference buffer underflow. In at least some embodiments, the VBR transcoder 102 applies equations (61)-(66) above to update the target bit budget.

In block 726, embodiments of the VBR rate controller 102 update the balance for the next picture in accordance with equation (67) above.

In block 728, embodiments of the VBR rate controller 102 update the number of bits consumed by recently transcoded pictures. The operations of block 628 can be applied to update the number of bits used for different picture types. In some VBR rate controller embodiments, β is set to two and applied in conjunction with equations (49)-(51).

While illustrative embodiments of this present disclosure have been shown and described, modifications thereof can be made by one skilled in the art without departing from the spirit or teaching of this present disclosure. The embodiments described herein are illustrative and are not limiting. Many variations and modifications of the system and apparatus are possible and are within the scope of the present disclosure. Accordingly, the scope of protection is not limited to the embodiments described herein, but is only limited by the claims which follow, the scope of which shall include all equivalents of the subject matter of the claims.

What is claimed is:

1. A video transcoder, comprising:
a video decoder that decodes an encoded source video bitstream to produce an image;
a video encoder that encodes the image to produce a transcoded video bitstream, and
a rate controller that controls the bit rate of the transcoded video bitstream, the rate controller comprising a macroblock level controller that provides a transcoder quantization parameter to the encoder;
wherein the macroblock level controller derives the transcoder quantization parameter applied to a transcoder macroblock by the encoder, at least in part, from a source quantization parameter of a corresponding macroblock in the source video bitstream.

2. The video transcoder of claim 1, wherein the macroblock level controller computes the transcoder quantization parameter based, at least in part, on source quantization parameters of a plurality of source video bitstream macroblocks corresponding to the transcoder macroblock.

3. The video transcoder of claim 1, wherein the macroblock level controller computes the transcoder quantization parameter based, at least in part, on the number of pixels of a source video bitstream macroblock contributing to the transcoder macroblock.

4. The video transcoder of claim 1, wherein the rate controller further comprises a picture level controller that computes, for each picture, a scaling value that, in the macroblock level controller, is multiplied by the source quantization parameter to produce the transcoder quantization parameter.

5. The video transcoder of claim 4, wherein the picture level controller bases the scaling value, at least in part, on a ratio of an estimated source bit rate to a transcoder output bit rate.

6. The video transcoder of claim 4, wherein the picture level controller bases the scaling value, at least in part, on a ratio of the number of pixels in a transcoded video frame to the number of pixels in a frame of the source video bitstream.

7. The video transcoder of claim 4, wherein the picture level controller estimates the structure of a group of pictures comprising a picture to be transcoded; wherein the rate controller determines the location of the current picture in the current group of pictures in bitstream order, estimates the intra/predictive frame interval, and estimates the intra coded frame interval.

8. The video transcoder of claim 4, wherein the picture level controller estimates a difference between an estimate of bits budgeted for allocation to a transcoded group of pictures and an estimate of bits consumed by group of pictures.

9. The video transcoder of claim 4, wherein the picture level controller estimates a bit rate of the source video bitstream.

10. The video transcoder of claim 4, wherein the picture level controller bases the scaling value, at least in part, on an estimate of the bit rate of the source video bitstream, a desired average transcoded bit rate, a number of pixels in a picture in the source video bitstream, a number of pixels in a transcoded picture, a reference buffer size, and an estimated bit balance at the end of a group of pictures.

11. The video transcoder of claim 4, wherein after each picture is transcoded, the picture level controller updates bit consumption for each picture type and updates a difference between actual and desired bit consumption.

12. The video transcoder of claim 4, wherein the picture level controller adjusts a desired number of bits for encoding a picture based, at least in part on a complexity of the picture.

13. A transcoding method, comprising:
decoding a source video bitstream;
deriving a transcoder quantization parameter applied to a transcoded macroblock, at least in part, from a source quantization parameter of a source video bitstream macroblock; and
encoding the transcoded macroblock using the transcoder quantization parameter.

14. The transcoding method of claim 13, further comprising computing the transcoder quantization parameter based, at least in part, on source quantization parameters of a plurality of source video bitstream macroblocks corresponding to the transcoded macroblock.

15. The transcoding method of claim 13, further comprising computing the transcoder quantization parameter based, at least in part, on the number of pixels of a source video bitstream macroblock contributing to the transcoded macroblock.

16. The transcoding method of claim 13, further comprising updating bit consumption of each of intra, predictive, and bi-predictive coded picture types, and updating a difference between actual and desired bit consumption after each picture is transcoded.

17. The transcoding method of claim 13, further comprising multiplying the source quantization parameter by a scaling factor determined for each picture, the multiplication producing the transcoder quantization parameter.

18. The transcoding method of claim 17, further comprising determining the scaling factor based, at least in part, on a ratio of the estimated source bit rate to the transcoder output bit rate.

19. The transcoding method of claim 17, further comprising determining the scaling factor based, at least in a part, on a ratio of the number of pixels in a transcoded video frame to the number of pixels in a frame of the source video bitstream.

20. The transcoding method of claim 17, further comprising estimating the structure of a group of pictures comprising a picture to be transcoded; said estimating comprising determining the location of the current picture in a current group of pictures in bitstream order, estimating the intra/predictive coded picture interval, and estimating the intra coded picture interval.

21. The transcoding method of claim 17, further comprising estimating a difference between an estimate of bits budgeted for allocation to a transcoded group of pictures and an estimate of bit consumed by group of pictures.

22. The transcoding method of claim 17, further comprising estimating a bit rate of the source video bitstream.

23. The transcoding method of claim 17, further comprising computing the scaling factor based, at least in part, on an estimate of the bit rate of the source video bitstream, a desired average transcoded bit rate, a number of pixels in a picture in the source video bitstream, a number of pixels in a transcoded picture, a reference buffer size, and an estimated bit balance at the end of a group of pictures.

24. The transcoding method of claim 13, further comprising adjusting a number of bits used to encode a picture, based at least in part, on a complexity of the picture.

25. A video bitrate controller, comprising:
a picture controller that, for each picture, computes a single quantizer scaling value applicable to all macroblocks of the picture; and
a macroblock controller that computes an encode quantization parameter used to encode a macroblock of the picture;
wherein the macroblock controller computes the encode quantization parameter as a product of the quantizer scaling value and a source quantization parameter extracted from a video bitstream.

26. The video bitrate controller of claim 25, wherein the encode quantization parameter is based, at least in part on the quantization applied to each pixel of the video bitstream contributing to an encoded macroblock.

27. The video bitrate controller of claim 25, wherein the picture controller bases the quantizer scaling value on at least one of a ratio of estimated source bit rate to encoder output rate, and a ratio of a number of pixels in an encoded video frame to a number of pixels in a frame of the video bitstream.

28. The video bitrate controller of claim 25, wherein the picture controller determines a number of bits used to encode a picture, based at least in part, on a complexity of the picture.
